(19) United States
(12) Patent Application Publication
(10) Pub. No.: US 2007/0076933 A1
(43) Pub. Date: Apr. 5, 2007

(54) Estimating the 0th and 1st moments in C-arm CT data for extrapolating truncated projections

(76) Inventors: Jared Starman, Stanford, CA (US); Norbert Pelc, Los Altos, CA (US); Norbert Karl Strobel, Palo Alto, CA (US); Rebecca Fahrig, Palo Alto, CA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/540,818

(22) Filed: Sep. 28, 2006

Related U.S. Application Data
(60) Provisional application No. 60/722,169, filed on Sep. 30, 2005.

(51) Int. Cl. G06K 9/00

(52) U.S. Cl. 382/128

(57) ABSTRACT

A method and system for implementing the method for extending the effective field of view of a CT scanner, comprising the steps of forming a preliminary estimate of the projection mass for each image projection, forming a preliminary estimate of the center of mass for each image projection, estimating the image mass and center of mass from the preliminary projection mass and center of mass projections, and forming a second estimate of the projection mass and center of mass from the image mass and center of mass.

### CROSS-REFERENCE TO RELATED APPLICATION AND CLAIM FOR PRIORITY

This application claims priority under 35 U.S.C. § 119(e) of copending Provisional Application Ser. No. 60/722,169 filed Sep. 30, 2005.

### BACKGROUND DESCRIPTION

1. Technical Field

The present invention relates generally to medical diagnostic imaging. More specifically the invention relates to extension or extrapolation of image data from a Computed Tomography (CT) transmission scan having a limited field of view so as to extend the CT projection data to a larger field of view, to enable image reconstruction without artifacts caused by missing projection data. In particular, the invention relates to the use of projection extrapolation without a priori knowledge for reconstruction of a CT image from transmission image data to compensate for missing data from the transmission image in an extended field of view (FOV) associated with reconstruction of an image of the entire object for tomographic imaging. The extended CT data can be used, for example, to generate attenuation correction factors for the corresponding PET or SPECT data, as well for reconstruction of CT images for coregistration with PET or SPECT reconstructed images.

2. Background of the Invention

With the advent of flat-panel detectors being used in cone-beam CT, it is common for the object being imaged to extend beyond the field of view (FOV) of the detector with respect to the various view angles needed for tomographic reconstruction. Because of this, the projection data collected at each position or angle with respect to the object do not contain all of the information required to reconstruct an image volume of the object. When conventional reconstruction algorithms are applied to such truncated projection data, image artifacts are produced that can obscure low contrast objects. Many different approaches have been taken to remove such artifacts caused by reconstruction using truncated projections. However, such approaches have fallen short for cases of severe truncation, which can be caused by very large objects, small detectors, or a combination of both.

Image reconstruction methods include iterative methods, such as Maximum-Likelihood-Expectation-Maximization (ML-EM) and Least Squares (LS), as well as traditional (non-iterative) reconstruction methods, such as filtered back-projection (FBP). Iterative reconstruction methods often provide better image quality and more natural ways to incorporate attenuation correction than non-iterative methods. However, iterative methods are generally more computationally intensive and more time-consuming than non-iterative methods. In fact, iterative techniques can be on the order of ten times slower than non-iterative techniques. Consequently, in the past iterative techniques were not used in the clinical environment as sufficient computational power was cost prohibitive.

Over a period of approximately fifteen years a number of studies have addressed attenuation correction of images obtained using tomographic techniques. According to U.S. Pat. No. 5,376,795, incorporated herein by reference, photon attenuation constitutes a major deficiency in diagnosis of heart disease with SPECT and is a major source of error in the measurement of tumor metabolism using radionuclide techniques. A number of researchers have shown that use of emission-transmission imaging techniques overcomes these limitations by combining anatomical (structural) information from transmission images with physiological (functional) information from radionuclide emission images. By correlating the emission and transmission images, the observer can more easily identify and delineate the location of radionuclide uptake. In addition, improvement of the quantitative accuracy of measurement of radionuclide uptake is possible using iterative reconstruction methods, which can account for errors and improve the radionuclide images.

Other studies in this area include disclosures of U.S. Pat. No. 5,739,539, incorporated herein by reference, which describes a method of performing image reconstruction in a gamma camera system that includes the steps of performing a transmission scan of an object about a number of rotation angles to collect transmission projection data and performing an emission scan of the object about numerous rotation angles to collect emission projection data. The outer boundary of the object is then located based on the transmission projection data. Information identifying the boundary is then either stored in a separate body contour map or embedded in an attenuation map. Information identifying the boundary can be in the form of flags indicating whether individual pixels are inside or outside the boundary of the object. The emission projection data is then reconstructed using the attenuation map, if desired, to generate transverse slice images. Image reconstruction requires less time if the process ignores pixels outside the body boundary.

U.S. Pat. No. 6,856,666, incorporated herein by reference, describes multimodality imaging methods and apparatus for scanning an object in a first modality, having a first field of view to obtain first modality data including fully sampled field of view data and partially sampled field of view data. The method also includes scanning the object in a second modality having a second field of view larger than the first field of view to obtain second modality data, and reconstructing an image of the object using the second modality data and the first modality partially sampled field of view data.

The following additional U.S. patents, each incorporated herein by reference, are cited as being exemplary of the prior art in the technological field of the present invention:

U.S. Pat. No. 6,631,284 and U.S. Pat. No. 6,490,476: Combined PET and X-ray CT Tomograph and Method for Using Same:

A combined PET and X-Ray CT tomograph for acquiring CT and PET images sequentially in a single device, overcoming alignment problems due to internal organ movement, variations in scanner bed profile, and positioning of the patient for the scan. In order to achieve good signal-to-noise (SNR) for imaging any region of the body, an improvement to both the CT-based attenuation correction procedure and the uniformity of the noise structure in the PET emission scan is provided. The PET/CT scanner includes an X-ray CT and two arrays of PET detectors mounted on a single support within the same gantry, and rotate the support to acquire a full projection data set for both imaging modalities. The tomograph acquires functional and anatomical images which are accurately co-registered, without the use of external markers or internal landmarks.

U.S. Pat. No. 6,339,652: Source-Assisted Attenuation Correction for Emission Computed Tomography:

A method of ML-EM image reconstruction is provided for use in connection with a diagnostic imaging apparatus that generates projection data. The method includes collecting projection data, including measured emission projection data and measured transmission projection data. Optionally, the measured transmission projection data is truncated. An initial emission map and attenuation map are assumed. The emission map and the attenuation map are iteratively updated. With each iteration, the emission map is recalculated by taking a previous emission map and adjusting it based upon: (i) the measured emission projection data; (ii) a reprojection of the previous emission map which is carried out with a multi-dimensional projection model; and, (iii) a reprojection of the attenuation map. As well, with each iteration, the attenuation map is recalculated by taking a previous attenuation map and adjusting it based upon: (i) the measured emission projection data; (ii) a reprojection of the previous emission map which is carried out with the multi-dimensional projection model; and (iii) measured transmission projection data.

U.S. Pat. No. 6,140,649: Imaging Attenuation Correction Employing Simultaneous Transmission/Emission Scanning:

A nuclear medical imaging system generates transmission and emission images simultaneously. The system includes a gamma camera and a linear transmission source disposed on opposite sides of an imaging region in which a patient lies. A plurality of views are taken at different rotational angles around a patient. At each angle, the view acquisition period is divided into two segments based on whether the transmission source is on or off. Emission image data is acquired either in both period segments or only while the transmission source is off. The transmission image data is acquired when the transmission source is on, and crosstalk image data is acquired when the transmission source is off.

U.S. Pat. No. 5,338,936: Simultaneous Transmission and Emission Converging Tomography:

A SPECT system includes three gamma camera heads which are mounted to a gantry for rotation about a subject. The subject is injected with a source of emission radiation, which emission radiation is received by the camera heads. Transmission radiation from a transmission radiation source is truncated to pass through a central portion of the subject but not peripheral portions and is received by one of the camera heads concurrently with the emission data. As the heads and radiation source rotate, the transmitted radiation passes through different parts or none of the peripheral portions at different angular orientations. An ultrasonic range arranger measures an actual periphery of the subject. Attenuation properties of the subject are determined by reconstructing the transmission data using an iterative approximation technique and the measured actual subject periphery. The actual periphery is used in the reconstruction process to reduce artifacts attributable to radiation truncation and the associated incomplete sampling of the peripheral portions. An emission reconstruction processor reconstructs the emission projection data and attenuation properties into an attenuation corrected distribution of emission radiation sources in the subject.

Each improvement in coregistration of multimodality image data and attenuation correction of nuclear medicine images provides benefits associated with the quality of medical diagnoses. For this reason there is continuing need for methods of image reconstruction for reliable reproduction of a patient's physical and functional condition.

### SUMMARY OF THE INVENTION

The present invention in its several disclosed embodiments provides a method of extending the effective field of view of a CT scanner, comprising the steps of forming a preliminary estimate of the projection moment or mass for each image projection using the following equations for a parallel geometry:

$$\begin{matrix}{m}_{0} ( {p}_{θ} ( t ) ) = {\int }_{- ∞}^{∞} {p}_{θ} ( t ) ⅆ t \\ = {\int }_{- ∞}^{∞} {\int }_{- ∞}^{∞} f ( x , y ) ⅆ x ⅆ y and\end{matrix}$$

$$\begin{matrix}{m}_{1} ( {p}_{θ} ( t ) ) = {\int }_{- ∞}^{∞} {tp}_{θ} ( t ) ⅆ t \\ = ( cos θ ) ( {\int }_{- ∞}^{∞} {\int }_{- ∞}^{∞} xf ( x , y ) ⅆ x ⅆ y ) + \\ ( sin θ ) ( {\int }_{- ∞}^{∞} {\int }_{- ∞}^{∞} yf ( x , y ) ⅆ x ⅆ y ) , where\end{matrix}$$

M₀ is the 0^{th} moment and m₁ is the 1^{st} moment, θ is the projection angle, and p_{θ} is the projection data,
forming a preliminary estimate of the center of mass for each image projection using the equation:
COM(p_{θ}(t))=m₁(p_{θ}(t))/m₀(p_{θ}(t)).
estimating the image mass and center of mass from the preliminary projection mass and center of mass projections, and forming a second estimate of the projection mass and center of mass from the image mass and center of mass.

Further provided is a system for extending the effective field of view of a CT scanner, comprising a data storage that receives data from the CT scanner, a data processing device in communication with the data storage device, and software that runs on the data processing device. The software utilizes a moment extrapolation algorithm to extend the effective field of view of the CT scanners.

### BRIEF DESCRIPTION OF THE DRAWINGS

The invention will now be described in greater detail in the following by way of example only and with reference to the attached drawings, in which:

FIG. 1 is a cross section of an image reconstructed from truncated projections of an abdomen.

FIG. 2 depicts a method of extending the effective view of a CT scanner in which not all the projections are truncated in accordance with an embodiment of the invention.

FIG. 3 depicts a method of extending the effective view of a CT scanner in which all the projections are truncated in accordance with another embodiment of the invention.

FIG. 4 is an example of a 1 D projection, mirroring of the data and performing an ellipse extrapolation.

FIG. 5 is an example of a projection using a single ellipse fit.

FIG. 6 is an example of a projection using separate ellipses to describe each truncated side independently.

FIG. 7 is an example of a moment extrapolated projection.

FIG. 8 is a depiction of a system that implements the method of extending the effective view of a CT scanner in accordance with the concepts of the invention.

### DETAILED DESCRIPTION OF EXEMPLARY EMBODIMENTS OF THE INVENTION

As required, disclosures herein provide detailed embodiments of the present invention; however, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

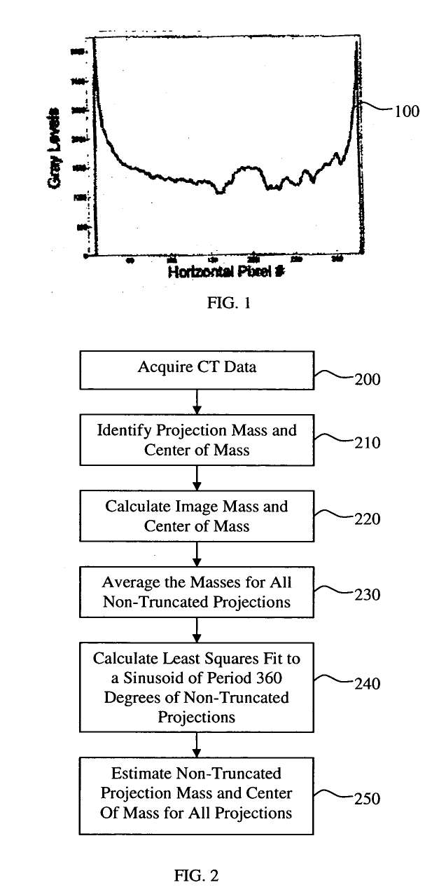

FIG. 1 depicts a traditional example of a cross section 100 of an abdomen from a CT scan. As can be seen in the cross section 100, the sides of the image are cut off. This cut off section is the area of the abdomen (in this example) that is truncated. The area beyond the cut off section is beyond the field of view (FOV) of the scan. These truncations affect the entire image and may make it impossible to do an accurate Hounsfield unit representation.

One method to overcome the truncations in accordance with an embodiment of the invention is through the use of a moment extrapolation algorithm, which does not use previous datasets or a priori knowledge. While exact reconstruction is not possible, very good results can be achieved. This method can be used for both 2D fan-beam reconstructions (1D projections) and 3D cone-beam reconstructions (2D projections). Only 2D reconstructions will be discussed.

FIG. 2 is a flow diagram of one embodiment of the method which may be used when not all the projections are truncated. The first step of the method may be to acquire CT data 200. The data may then be used make a first projection estimate. This may be accomplished by identifying the projection mass (or 0^{th} moment) and the center of mass (or 1^{st} moment) 210. Given the definition of a parallel projection in the x-y coordinate plane at projection angle θ:

$${p}_{θ} ( t ) = {\int }_{- ∞}^{∞} {\int }_{- ∞}^{∞} f ( x , y ) δ ( x cos θ + y sin θ - t ) ⅆ x ⅆ y \qquad ( 1 )$$

The n^{th} projection mass mₙ can be written as:

$$\begin{matrix}{m}_{n} ( {p}_{θ} ( t ) ) = {\int }_{- ∞}^{∞} {t}^{n} {p}_{θ} ( t ) ⅆ t \\ = {\int }_{- ∞}^{∞} {\int }_{- ∞}^{∞} f ( x , y ) {( x cos θ + y sin θ )}^{n} ⅆ x ⅆ y\end{matrix} \qquad ( 2 )$$

Equations for the 0^{th} and 1^{st} moments can then be written as:

$$\begin{matrix}\begin{matrix}{m}_{0} ( {p}_{θ} ( t ) ) = {\int }_{- ∞}^{∞} {p}_{θ} ( t ) ⅆ t \\ = {\int }_{- ∞}^{∞} {\int }_{- ∞}^{∞} f ( x , y ) ⅆ x ⅆ y\end{matrix} & ( 3 ) \\ and & \\ \begin{matrix}{m}_{1} ( {p}_{θ} ( t ) ) = {\int }_{- ∞}^{∞} {tp}_{θ} ( t ) ⅆ t \\ = ( cos θ ) ( {\int }_{- ∞}^{∞} {\int }_{- ∞}^{∞} xf ( x , y ) ⅆ x ⅆ y ) + \\ ( sin θ ) ( {\int }_{- ∞}^{∞} {\int }_{- ∞}^{∞} yf ( x , y ) ⅆ x ⅆ y )\end{matrix} & ( 4 )\end{matrix}$$

The right most integral in Eq. (3) is the 0^{th} moment or image mass and the double integrals in Eq. (4) are the first moments of the image around the x and y axes respectively. Thus, Eqs. (3) and (4) relate the 0^{th} and 1^{st} moments of the true, non-truncated projection to the 0^{th} and 1^{st} moments of the 2D image object.

Eq. (3) can be seen to be independent of projection angle θ, which means that all projections should have the same projection mass, which is equal to the image mass. Thus, the difference between the image mass and the projection mass of the truncated projection is the sum total of all the projection mass that is missing. The goal of the moment extrapolation algorithm is to add this exact amount of data back to the projection signal.

Eq. (4) relates the 1^{st} moment of each parallel projection to a linear combination of the first moments of the image. The first moment of a projection can be turned into the center of mass (COM) by normalizing the 1^{st} moment by the 0^{th} mass as seen in Eq. (5) below for a projection taken at angle θ.
COM(p_{θ}(t))=m₁(p_{θ}(t))/m₀(p_{θ}(t)) (5)
A similar operation can be done to calculate the COM for an image.

The COM is an actual position inside the projection or image. Its placement gives the centroid of the signal, and indicates how the mass is distributed over the signal. Thus, by knowing the COM of the true, non-truncated projections, both sides of the truncated projections can be extrapolated with the correct amount of mass that is missing from each side.

Knowing the image mass and the COM, Eqs. (3)-(5) fully constrain the projection mass and COM for every projection in a parallel geometry. While this is not strictly true for fan beam geometry, good results can still be achieved by making the assumption that these relationships also hold for divergent geometries. This is especially true when the object being imaged is placed near the center of rotation and the fan angle is small.

Given a truncated set of projections with no a priori knowledge of the non-truncated mass and COM, those moments need to be estimated before moment extrapolation can be performed. Mass and COM information can be estimated in several ways, such as from auxiliary images obtained at the same time as the CT scan of the object but with a different geometry (where the auxiliary image either includes the entire object or is obtained from multiple side-by-side projection images), a previously reconstructed dataset, or directly from the truncated dataset to be extrapolated.

Once the projection mass and COM 210 are identified, an estimation of the image mass and COM from the preliminary projection mass and COM estimates may be calculated 220. In the embodiment of FIG. 2, where not all the projections are truncated, the image mass may be estimated by taking the average of the masses for all the non-truncated projections 230. The image COM, on the other hand, may be estimated by calculating a least squares fit to a sinusoid of period 360 degrees of the non-truncated projections 240.

Finally, a second projection estimate may be made. Using Eqs. (3)-(5), the non-truncated projection mass and COM for all projections are estimated 250. The projection mass may be assumed to equal the image mass. The COM for each projection is a linear combination of COMₓ and COM_{y} f the image.

Once the projection mass and COM for the non-truncated projections have been estimated, the following constraints may be applied for projection extrapolation: 1) the total mass of the final extrapolated projection must equal the image mass and 2) the final COM of the extrapolated projection must be located in accordance with the image COM. Using the target mass and COM values, first order polynomials may be used to extrapolate the truncated projections in keeping with the two constraints. A 1D example of an extrapolated projection can be seen in FIG. 7. It is also important that the edge of the extrapolated part of the signal be smoothed so that it maintains a smooth (i.e. continuous) 1^{st} derivative immediately across the boundary into the extrapolated region.

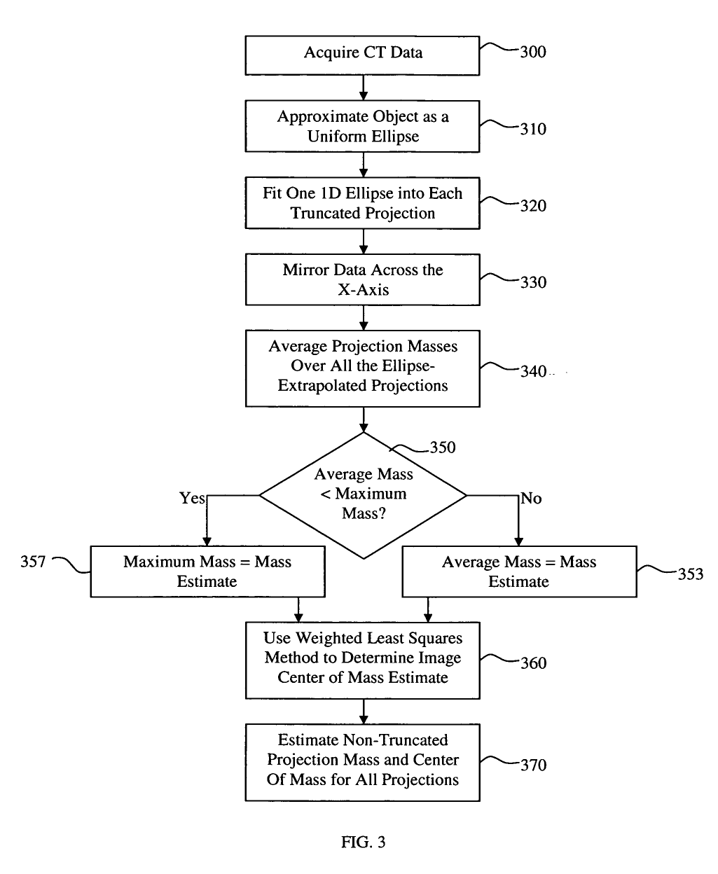

FIG. 3 shows another embodiment of the method where all of the projections are truncated. After acquiring the CT data 300, two assumptions may be made. First, the object being imaged is approximated as a uniform ellipse 310. Second, the projections of an ellipse are assumed to have an elliptical 1D profile. Thereafter, a 1D ellipse may be fit to each truncated projection via least squares 320. See FIG. 5 for an example of a single ellipse fit projection. To ensure that one of the axes of the ellipse lies on the x-axis, the data is mirrored across the x-axis 330.

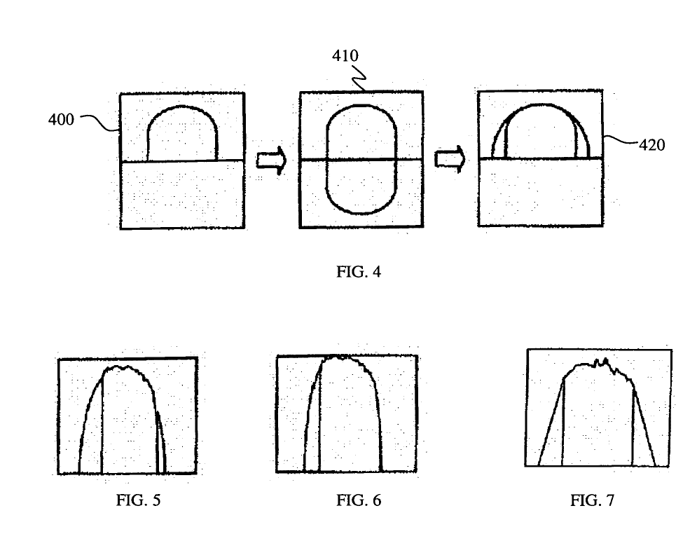

Looking at FIG. 4, an example of an original truncated 1D projection data 400 is shown. The 1D projection data is reflected across the x-axis 410 to ensure that one of the ellipse axes lies on the horizontal axis. Finally, 420 is an example of an ellipse-extrapolated projection data.

FIG. 6 shows another embodiment in which two distinct ellipses may be fit to the truncated projection, one to each of the outer 25% of each side of the projection. This way both sides of the projection can be described independently.

In another embodiment (not shown) both approaches, i.e. the single ellipse approach and double ellipse approach, are used.

Looking back to FIG. 3, the next step in this embodiment may be to obtain an image estimate. To compute the image mass estimate, an average of the projection masses may be taken over all the ellipse-extrapolated projections 340. M₀^{max} is defined as the maximum mass over all the truncated projections. If the average ellipse-extrapolated mass is less than M₀^{max} 350, M₀^{max} becomes the image mass estimate 357 otherwise the average mass is the mass estimate 353.

A weighted least squares method may be used to determine the parallel geometry equivalent COM 360. The weights may be determined from the truncated mass for each projection, which are known, and are then normalized between 0 and 1. To determine the image COM, Eq. (6), below, may be used.

$${w}_{θ} * COM ( {p}_{θ} ( t ) ) = {w}_{θ} * [ \begin{matrix}cos ( θ ) & sin ( θ )\end{matrix} ] * [ \begin{matrix}{COM}_{x} ( f ( x , y ) ) \\ {COM}_{y} ( f ( x , y ) )\end{matrix} ] \qquad ( 6 )$$

The weights maybe calculated by Eq. (7)

$${w}_{θ} = \frac{{M}_{0} ( {p}_{t} ( θ ) ) - {M}_{0}^{min}}{{M}_{0}^{max} - {M}_{0}^{min}} \qquad ( 7 )$$

wherein θ is the projection angle, M₀^{min} is the minimum mass of all the truncated projections, COM(p_{θ}(t)) is the 1D projection COM, and COMₓ and COM_{y} are the components of the parallel equivalent 2D image COM. All parameters except for the image COM are known, so they can be estimated using the least squares method.

Finally, a second projection estimate may be made. Using Eqs. (3)-(5), the non-truncated projection mass and COM for all projections are estimated 370. The projection mass may be assumed to equal the image mass. The COM for each projection is a liner combination of COMₓ and COM_{y} of the image.

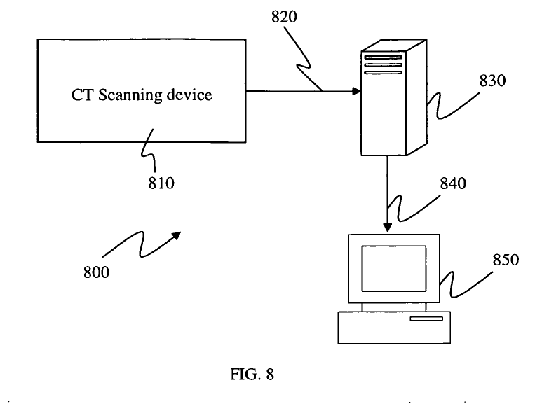

FIG. 8 depicts an embodiment of a system 800 for implementing the method disclosed above. The system 800 includes a CT scanning device 810. Once the CT scan is complete, a storage device 830 may obtain the scanned data 820 from the CT scanning device 810 and may store the data until the processor 850 is ready for it. Once the moment extrapolation algorithm software is initiated, the processor 850 may obtain the stored data 840 from the storage device 830. The processor 850 may be capable of executing software that utilizes the moment extrapolation algorithm as described above. The processor may further be capable of interfacing with a PET scanner and combining the data scans from the two machines.

The invention having been thus described, it will be apparent to those skilled in the art that the same may be varied in many ways without departing from the spirit and scope of the invention. Any and all such variations are intended to be encompassed within the scope of the following claims.

What is claimed is:

1. A method of extending the effective field of view of a CT scanner with respect to an object being imaged, comprising:
(a) forming a preliminary estimate of the projection mass of said object for each image projection using the equations:
$$\begin{matrix}{m}_{0} ( {p}_{θ} ( t ) ) = {\int }_{- ∞}^{∞} {p}_{θ} ( t ) ⅆ t \\ = {\int }_{- ∞}^{∞} {\int }_{- ∞}^{∞} f ( x , y ) ⅆ x ⅆ y and\end{matrix}$$
$$\begin{matrix}{m}_{1} ( {p}_{θ} ( t ) ) = {\int }_{- ∞}^{∞} {tp}_{θ} ( t ) ⅆ t \\ = ( cos θ ) ( {\int }_{- ∞}^{∞} {\int }_{- ∞}^{∞} xf ( x , y ) ⅆ x ⅆ y ) + \\ ( sin θ ) ( {\int }_{- ∞}^{∞} {\int }_{- ∞}^{∞} yf ( x , y ) ⅆ x ⅆ y ) ;\end{matrix}$$
(b) forming a preliminary estimate of the center of mass (COM) for each image projection using the equation:
COM(p_{θ}(t))=m₁(p_{θ}(t))/m₀(p_{θ}(t));
(c) estimating the image mass and center of mass from the preliminary projection mass and center of mass projections;
(d) forming a second estimate of the projection mass and center of mass from the image mass and center of mass; and
(e) using the projection mass estimates and center of mass estimates to extrapolate projection image data into a truncated region of said object image.

2. The method of claim 1, wherein steps (a) and (b) further comprise comparing the edges of the projection mass and the center of mass to a threshold value.

3. The method of claim 2, further comprising calculating the projection mass and center of mass for each non-truncated projection.

4. The method of claim 1, further comprising:
(i) extrapolating a truncated projection as at least one uniform ellipse;
(ii) fitting at least one one dimensional ellipse into each truncated projection; and
(iii) mirroring data across an x-axis.

5. The method of claim 1, wherein step (c) is accomplished by:
(i) averaging the masses for all non-truncated projections to estimate the image mass; and
(ii) calculating a least squares fit to a sinusoid of period 360 degrees of the non-truncated projections to estimate the center of mass.

6. The method of claim 4, wherein step (c) of claim 1 is accomplished by:
(i) averaging the projection masses over all the ellipse-extrapolated projections;
(ii) using the larger of the average projection mass and the maximum mass over all the truncated projections as the image mass;
(iii) using a weighted least squares method to determine the parallel geometry equivalent center of mass;
(iv) using the equation:
$${w}_{θ} * COM ( {p}_{θ} ( t ) ) = {w}_{θ} * [ \begin{matrix}cos ( θ ) & sin ( θ )\end{matrix} ] * [ \begin{matrix}{COM}_{x} ( f ( x , y ) ) \\ {COM}_{y} ( f ( x , y ) )\end{matrix} ]$$
to calculate image center of mass, wherein the equation:
$${w}_{θ} = \frac{{M}_{0} ( {p}_{t} ( θ ) ) - {M}_{0}^{min}}{{M}_{0}^{max} - {M}_{0}^{min}}$$
is used to calculate the weights.

7. The method of claim 1, wherein step (d) is accomplished by using the equations of steps (a) and (b).

8. The method of claim 1, further comprising applying the constraints of:
(i) the total mass of the final extrapolated projection equals the image mass; and
(ii) the final center of mass of the extrapolated projection is located in accordance with the image center of mass.

9. The method claim 8, further comprising using first order polynomials to extrapolate truncated projections.

10. A system for extending the effective field of view of a CT scanner with respect to an object being imaged, comprising:
a data storage device in communication with the CT scanner;
a data processing device in communication with the data storage device; and
software executing on the data processing device wherein the software utilizes a moment extrapolation algorithm to extend the effective field of view of the CT scanner, said algorithm being based on 0^{th} and 1^{st} moment estimation.

11. The system of claim 10, further comprising a data output device.

12. The system of claim 10, wherein the algorithm further utilizes the equations:
$$\begin{matrix}{m}_{0} ( {p}_{θ} ( t ) ) = {\int }_{- ∞}^{∞} {p}_{θ} ( t ) ⅆ t \\ = {\int }_{- ∞}^{∞} {\int }_{- ∞}^{∞} f ( x , y ) ⅆ x ⅆ y and\end{matrix}$$
$$\begin{matrix}{m}_{1} ( {p}_{θ} ( t ) ) = {\int }_{- ∞}^{∞} {tp}_{θ} ( t ) ⅆ t \\ = ( cos θ ) ( {\int }_{- ∞}^{∞} {\int }_{- ∞}^{∞} xf ( x , y ) ⅆ x ⅆ y ) + \\ ( sin θ ) ( {\int }_{- ∞}^{∞} {\int }_{- ∞}^{∞} yf ( x , y ) ⅆ x ⅆ y )\end{matrix}$$
to determine the projection mass of a scanned truncated projection.

13. The system of claim 10, wherein the algorithm further utilizes the equation:
COM(p_{θ}(t))=m₁(p_{θ}(t))/m₀(p_{θ}(t))
to determine the center of mass of a scanned truncated projection.

14. The system of claim 10, wherein the algorithm uses no a priori knowledge to extend the effective field of view of a CT scanner.

15. A method of extending the effective field of view of a CT scanner with respect to an object being imaged, comprising:
(a) forming a preliminary estimate of the 0^{th} and 1^{st} projection mass of said object for each image projection;
(b) forming a preliminary estimate of the center of mass for each image projection using said 0^{th} and 1^{st} projection mass estimates;
(c) estimating the image mass and center of mass from the preliminary projection mass and center of mass projections;
(d) forming a second estimate of the projection mass and center of mass from the image mass and center of mass; and
(e) using the projection mass estimates and center of mass estimates to extrapolate projection image data into a truncated region of said object image.

16. The method of claim 15, wherein mass and COM estimates are obtained from auxiliary projection images taken at the same time as a CT scan of the object being imaged, from a geometry different than that of said CT scan.

17. The method of claim 16, wherein said auxiliary images contain the full object being imaged.

18. The method of claim 16, wherein said auxiliary images are assembled from multiple side-by-side projection images.

19. The method of claim 16, wherein mass and COM estimates are obtained from auxiliary projection images taken at the same time as a CT scan of the object being imaged, from a geometry different than that of said CT scan.

20. The method of claim 19, wherein said auxiliary images contain the full object being imaged.

21. The method of claim 19, wherein said auxiliary images are assembled from multiple side-by-side projection images.
